(19) United States
(12) Patent Application Publication
(10) Pub. No.: US 2011/0260032 A1
(43) Pub. Date: Oct. 27, 2011

(54) Motor Base

(76) Inventors: Alex Horng, Kaohsiung (TW); Chia-Chin Wu, Kaohsiung (TW); Shou-Chien Chang, Kaohsiung (TW); Hung-Jen Chuan, Kaohsiung (TW)

(21) Appl. No.: 12/765,976

(22) Filed: Apr. 23, 2010

(51) Int. Cl. H02K 5/20; H02K 5/00

(52) U.S. Cl. 248/678

(57) ABSTRACT

A motor base comprises a supporting member and an enclosure member. The supporting member has an outer surface and an inner surface, wherein the inner surface defines a through-hole. One side of the through-hole forms an opening portion and another side of the through-hole forms a coupling portion. The enclosure member is coupled to the opening portion of the supporting member and has a first surface and a second surface opposing to the first surface. The first surface faces the through-hole of the supporting member. The enclosure member further comprises at least one vent extending from the first surface to the second surface thereof.

### BACKGROUND OF THE INVENTION

1. Field of the Invention

The present invention generally relates to a motor base and, more particularly, to a motor base to be coupled by members such as a coil unit or rotor in order to form a motor or cooling fan.

2. Description of the Related Art

Referring to FIG. 1, a conventional motor 8 is disclosed. The conventional motor 8 comprises a motor base 81, a housing 82, a driving assembly 83 and a rotor 84. The motor base 81 comprises a bottom ring 811 which may be coupled to a cover 812. The housing 82 is formed in an integral molding manner on an end of the bottom ring 811. The driving assembly 83 is disposed in the housing 82 and comprises a coil unit 831 and a circuit board 832 electrically connected to the coil unit 831. The rotor 84 has a shaft 841 rotatably coupled to the housing 82, as well as a permanent magnet 842 located in the housing 82. An air gap is formed between the permanent magnet 842 and the coil unit 831. In this way, the coil unit 831 may drive the rotor 84 to rotate when the coil unit 831 is electrified to generate magnetic fields which interact with the permanent magnet 842 of the rotor 84.

The bottom ring 811 of the motor base 81 may be further coupled to a frame 9 via a plurality of ribs 91. The rotor 84 may have a plurality of vanes 843 formed on an outer periphery thereof. Based on this, the frame 9 may be equipped in an electronic device. During rotation of the rotor 84, the vanes 843, through the structural design of the frame 9, may direct air to a certain part of the electronic device where heat air is often generated for cooling purposes.

Since the driving assembly 83 of the motor 8 is disposed inside the housing 82 and the circuit board 832 of the driving assembly 83 must be electrified in order for the coil unit 831 to generate magnetic fields, the driving assembly 83 may easily generate a significant amount of heat during operation. However, the motor base 81 does not provide any structural designs for cooling purposes of the driving assembly 83; for example, the bottom ring 811 may only be used to support the housing 82 and the cover 812 may only be used to close the housing 82. Therefore, it is difficult to dispel the heat generated by the driving assembly 83, leading to a decreased service life of the motor 8.

### SUMMARY OF THE INVENTION

It is therefore the primary objective of this invention to overcome the drawbacks of the conventional motor base and to provide a motor base with cooling mechanism.

The invention discloses a motor base comprising a supporting member and an enclosure member. The supporting member has an outer surface and an inner surface, wherein the inner surface defines a through-hole. One side of the through-hole forms an opening portion and another side of the through-hole forms a coupling portion. The enclosure member is coupled to the opening portion of the supporting member and has a first surface and a second surface opposing to the first surface. The first surface faces the through-hole of the supporting member. The enclosure member further comprises at least one vent extending from the first surface to the second surface thereof.

Furthermore, the invention discloses a motor base comprising a supporting member and an enclosure member. The supporting member has an outer surface and an inner surface, wherein the inner surface defines a through-hole. One side of the through-hole forms an opening portion and another side of the through-hole forms a coupling portion. The enclosure member is coupled to the opening portion of the supporting member and has a first surface and a second surface opposing to the first surface. The first surface faces the through-hole of the supporting member. The supporting member further comprises at least one ventilation opening extending from the outer surface to the inner surface thereof.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows a side cross sectional view of a conventional motor with a motor base.

FIG. 2 shows an exploded diagram of a motor base according to a first embodiment of the invention.

FIG. 3 shows a side cross sectional view of the motor base according to the first embodiment of the invention.

FIG. 4 shows a side cross sectional view of a motor or cooling fan utilizing the motor base in the first embodiment of the invention.

FIG. 5 shows an exploded diagram of a motor base according to a second embodiment of the invention.

FIG. 6 shows a side cross sectional view of the motor base according to the second embodiment of the invention.

FIG. 7 shows a side cross sectional view of a motor or cooling fan utilizing the motor base in the second embodiment of the invention.

FIG. 8 shows an exploded diagram of a motor base according to a third embodiment of the invention.

FIG. 9 shows a side cross sectional view of the motor base according to the third embodiment of the invention.

FIG. 10 shows a side cross sectional view of a motor or cooling fan utilizing the motor base in the third embodiment of the invention.

In the various figures of the drawings, the same numerals designate the same or similar parts. Furthermore, when the term “first”, “second”, “third”, “fourth”, “inner”, “outer” “top”, “bottom” and similar terms are used hereinafter, it should be understood that these terms are reference only to the structure shown in the drawings as it would appear to a person viewing the drawings and are utilized only to facilitate describing the invention.

### DETAILED DESCRIPTION OF THE INVENTION

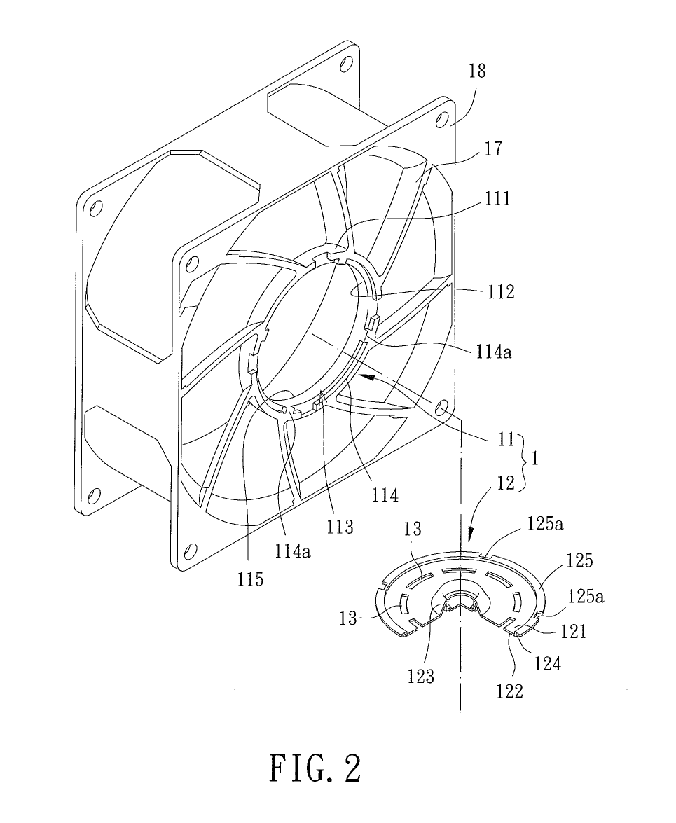

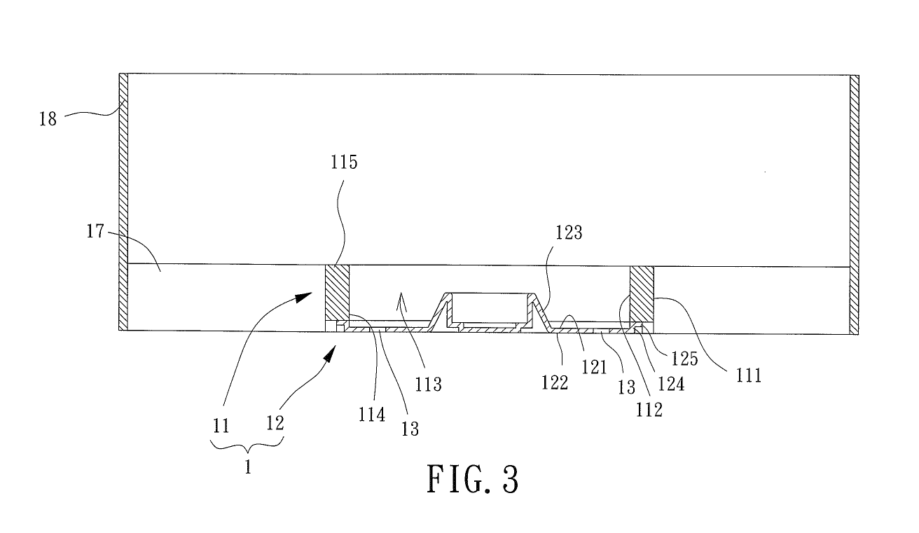

Referring to FIGS. 2 and 3, a motor base 1 is disclosed according to a first embodiment of the invention. The motor base 1 at least comprises a supporting member 11 and an enclosure member 12. The supporting member 11 and the enclosure member 12 may be coupled together to form the motor base 1 applicable to any motors or cooling fans.

The supporting member 11 is preferably in an annual form and has an outer surface 111 and an inner surface 112. The inner surface 112 defines a through-hole 113, with one side of the through-hole 113 forming an opening portion 114 and another side of the through-hole 113 forming a coupling portion 115. The opening portion 114 preferably has a plurality of buckling protrusions 114a. The coupling portion 115 may be coupled to a housing (which will be described later).

The enclosure member 12 is coupled to the opening portion 114 of the supporting member 11. The enclosure member 12 has a first surface 121 and a second surface 122 opposing to the first surface 121. The first surface 121 faces the through-hole 113 of the supporting member 11 and preferably has a shaft seat 123 for receiving a shaft (which will be described later). In addition, the first surface 121 may form a protruding portion 124 on a periphery of the enclosure member 12, with the protruding portion 124 surrounding the shaft seat 123. The protruding portion 124 may form a protruding ring 125 preferably having a plurality of notches 125a, each corresponding to a respective buckling protrusion 114a. The number of the notches 125a may be the same as that of the buckling protrusions 114a so that each buckling protrusion 114a may be buckled into a corresponding notch 125a when the enclosure member 12 is coupled to the opening portion 114. Thus, the enclosure member 12 is efficiently coupled to the supporting member 11 and undesired moving of the enclosure member 12 is also avoided.

The enclosure member 12 has a plurality of vents 13 (or may only be one vent, depending on requirements) extending from the first surface 121 to the second surface 122. Thus, ventilation and cooling effect are provided.

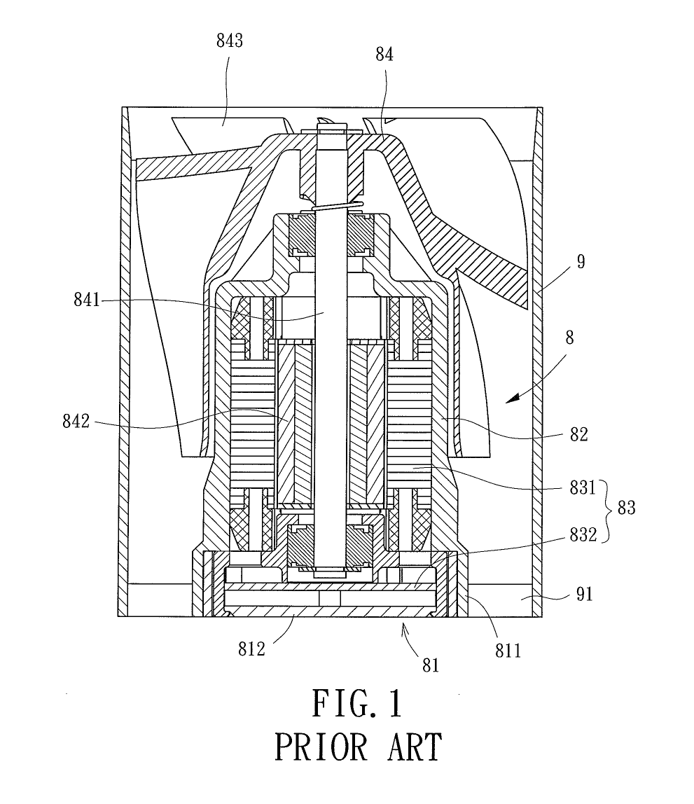

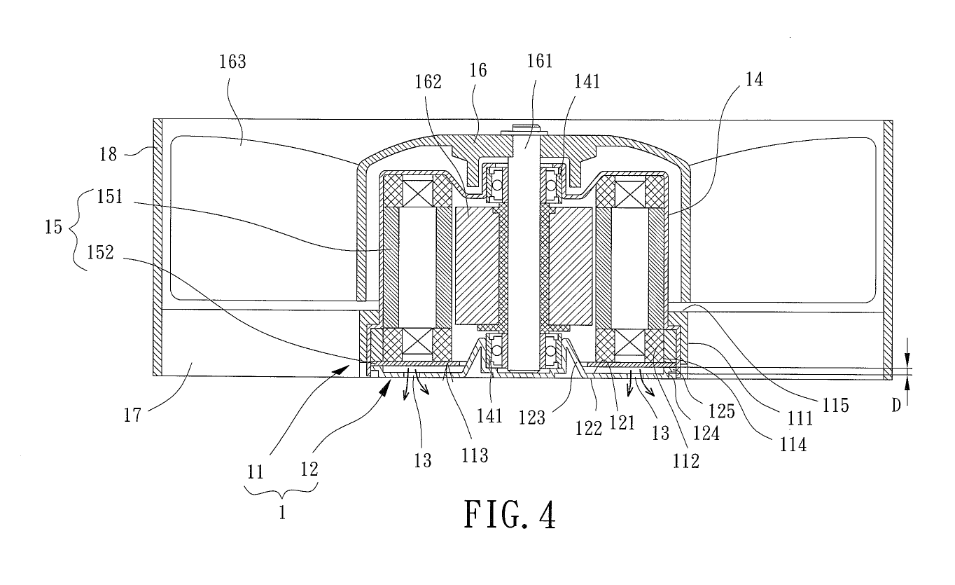

Referring to FIG. 4 also, the motor base 1 is shown to be applied to a motor in a cooling fan. As shown in the FIGS. 1 to 4, the motor base 1 may be applied to inner-rotor-type motors as well as cooling fans with an inner-rotor-type motor.

The coupling portion 115 of the supporting member 11 may be coupled to a housing 14. The supporting member 11 may be integrally formed with the housing 14. Alternatively, the housing 14 as an independent member may be assembled to the supporting member 11. The housing 14 may be coupled to a plurality of bearings 141, with one of the bearings 141 being further coupled to the shaft seat 123 and located inside the housing 14.

A driving assembly 15 and a rotor 16 are also provided. The driving assembly 15 is disposed in the housing 14 via the opening portion 114 and the through-hole 113. The driving assembly 15 comprises a coil unit 151 and a circuit board 152 electrically connected to the coil unit 151. The rotor 16 has a shaft 161 rotatably coupled to the bearings 141, as well as a permanent magnet 162 located inside the housing 14. An air gap is formed between the permanent magnet 162 and the coil unit 151. In this way, the rotor 16 starts rotating once the coil unit 151 is electrified to generate magnetic fields which interact with the permanent magnet 162 of the rotor 16.

The enclosure member 12 is provided to close the opening portion 114 of the supporting member 11 such that the driving assembly 15 and the bearings 141 are prevented from disengaging from the housing 14. Based on this, the supporting member 11, enclosure member 12 and housing 14 form a motor applicable to any cooling fan. For example, the supporting member 11 may have a plurality of connection members 17 on an outer surface thereof, with the connection members 17 being coupled to a frame 18. The rotor 16 may have a plurality of vanes 163 on an outer circumferential surface thereof.

The motor base 1 in the first embodiment is characterized by that the heat generated by the driving assembly 15 may be dispelled out of the housing 14 via the vents 13 when the motor base 1 is used in a motor or cooling fan as shown in FIG. 4. Through the cooling mechanism provided by the motor base 1, the temperature of the driving assembly 15 may be kept, thereby prolonging the service life of the motor or cooling fan.

Referring to FIG. 4 again, the circuit board 152 may be disposed between the protruding ring 125 and the coil unit 151 during assembly of the circuit board 152. More importantly, it is ensured that a spacing D is formed between the circuit board 152 and the first surface 121 of the enclosure member 12. In this way, the heat generated by the driving assembly 15 may be dispelled out of the housing 14 via the spacing D and the vents 13.

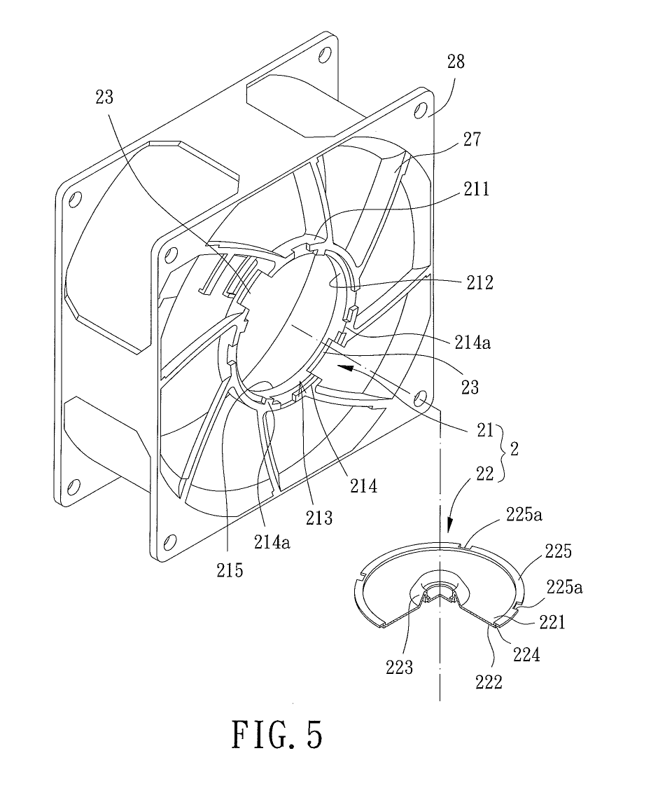

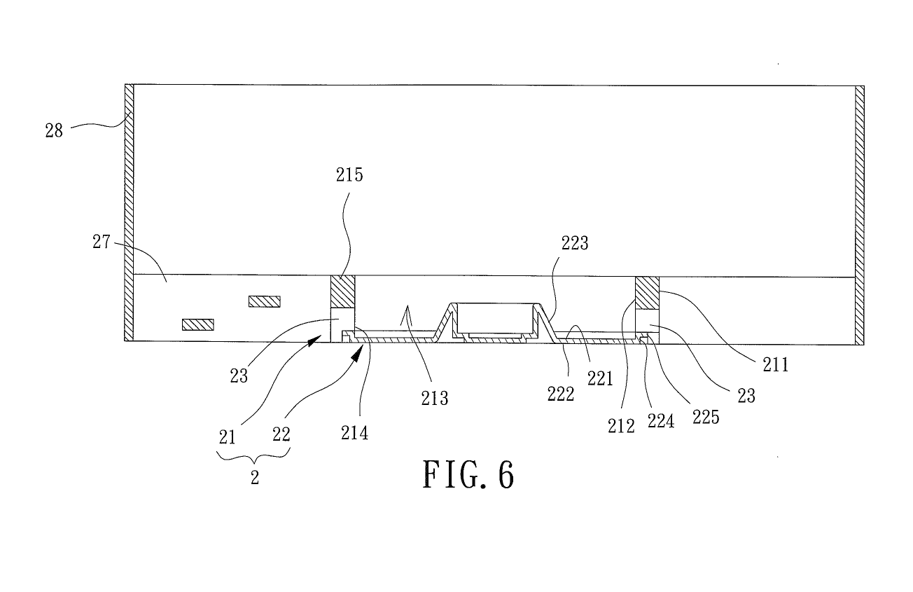

Referring to FIGS. 5 and 6, a motor base 2 is disclosed according to a second embodiment of the invention. The motor base 2 comprises a supporting member 21 and an enclosure member 22. In FIG. 5, an outer surface 211, inner surface 212, through-hole 213, opening portion 214, coupling portion 215 and a plurality of buckling protrusions 214a, as well as a first surface 221, second surface 222, shaft seat 223, protruding portion 224, protruding ring 225 and a plurality of notches 225a, are similar to those described in the first embodiment, so they are not described herein again for brevity.

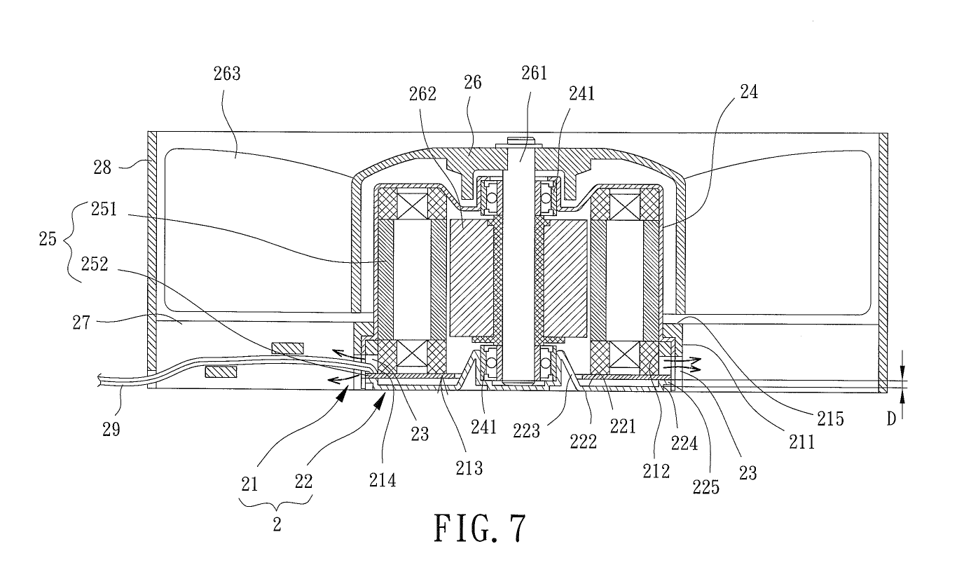

Referring to FIG. 7, the motor base 2 may also be applied to a motor or cooling fan. The related components such as housing 24, a plurality of bearings 241, driving assembly 25, coil unit 251, circuit board 252, rotor 26, shaft 261, permanent magnet 262, a plurality of vanes 263, a plurality of connection members 27 and frame 28 are similar to those described in the first embodiment, so they are not described herein again for brevity.

Referring to FIGS. 5 to 7, the motor base 2 in the second embodiment is differed from the motor base 1 in the first embodiment by that the enclosure member 22 does not have a plurality of vents such as the vents 13 disclosed in the first embodiment. Instead, the supporting member 21 is designed to have a plurality of ventilation openings 23 (or may only be one ventilation opening, depending on requirements) extending from the outer surface 211 to the inner surface 212 thereof. In this way, air circulation may be provided by the ventilation openings 23 so that cooling purposes are achieved.

The motor base 2 in the second embodiment is characterized by that the heat generated by the driving assembly 25 may be dispelled out of the housing 24 via the ventilation openings 23. More importantly, when two ventilation openings 23 are provided, one ventilation opening 23 may be located opposing to another one. Therefore, air convection is achieved and cooling effect is thus improved. Furthermore, when the motor base 2 comprises a plurality of ventilation openings 23, one of the ventilation openings 23 may be used for wire-retaining purpose. In other words, the chosen ventilation opening 23 is used to pass a power line of the circuit board 252 therethrough. Thus, convenient assembly is provided.

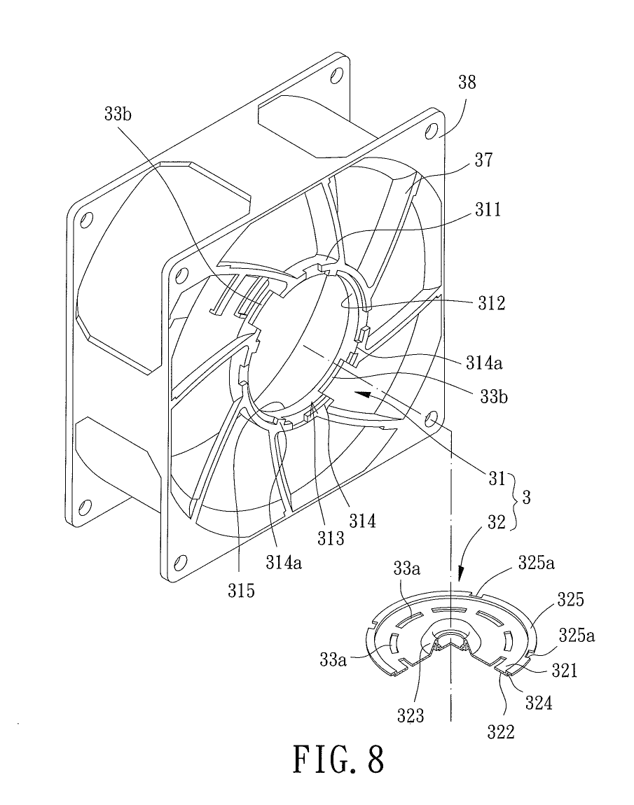

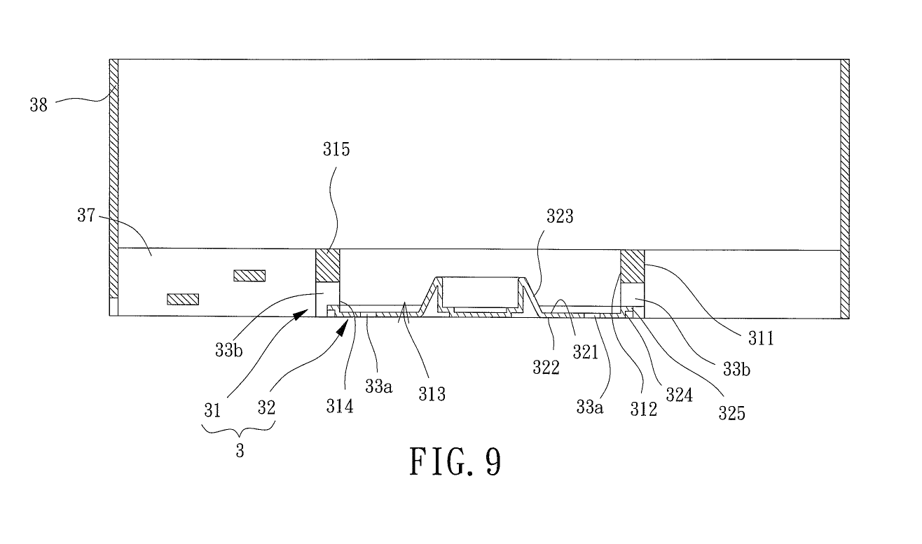

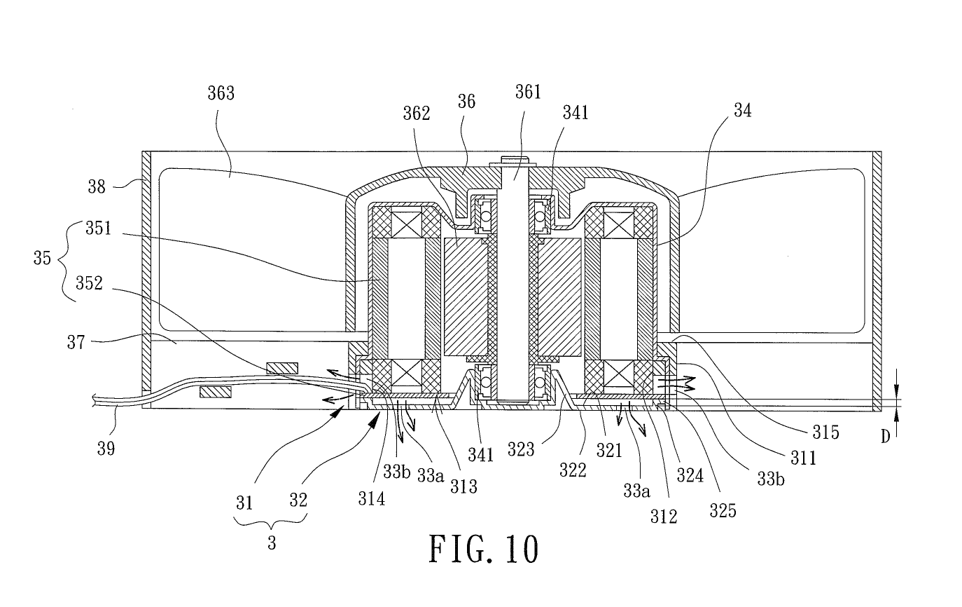

Referring to FIGS. 8 and 9, a motor base 3 is disclosed according to a third embodiment of the invention. The motor base 3 comprises a supporting member 31 and an enclosure member 32. In FIG. 8, an outer surface 311, inner surface 312, through-hole 313, opening portion 314, coupling portion 315 and a plurality of buckling protrusions 314a, as well as a first surface 321, second surface 322, shaft seat 323, protruding portion 324, protruding ring 325 and a plurality of notches 325a, are similar to those described in the previous two embodiments, so they are not described herein again for brevity. Referring to FIG. 10, the motor base 3 may also be applied to a motor or cooling fan. The related components such as housing 34, a plurality of bearings 341, driving assembly 35, coil unit 351, circuit board 352, rotor 36, shaft 361, permanent magnet 362, a plurality of vanes 363, a plurality of connection members 37, frame 38 and power line 39 are similar to those described in the previous two embodiments, so they are not described herein again for brevity.

Referring to FIGS. 8 to 10, the motor base 3 in the third embodiment is differed from the motor bases 1 and 2 in the first and second embodiments by that the enclosure member 32 is designed to have a plurality of vents 33a (or may only be one vent, depending on requirements) extending from the first surface 321 to the second surface 322 thereof. In addition, the supporting member 31 is designed to have a plurality of ventilation openings 33b (or may only be one ventilation opening, depending on requirements) extending from the outer surface 311 to the inner surface 312 thereof. In this way, the motor base 3 in the third embodiment may achieve all the advantages of the motor bases 1 and 2.

Based on the above description, when the motor bases 1, 2 and 3 are applied to motors or cooling fans, better cooling mechanism of the driving assemblies 15, 25 and 35 are provided. Thus, service life of the motors and cooling fans is prolonged.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. A motor base, comprising:
a supporting member having an outer surface and an inner surface, wherein the inner surface defines a through-hole, one side of the through-hole forms an opening portion and another side of the through-hole forms a coupling portion; and
an enclosure member coupled to the opening portion of the supporting member and having a first surface and a second surface opposing to the first surface, wherein the first surface faces the through-hole of the supporting member,
wherein the enclosure member further comprises at least one vent extending from the first surface to the second surface thereof.

2. The motor base as claimed in claim 1, wherein the supporting member comprises at least one ventilation opening extending from the outer surface to the inner surface thereof.

3. The motor base as claimed in claim 2, wherein the number of the at least one ventilation opening is two, and the two ventilation openings are opposing to each other.

4. The motor base as claimed in claim 1, wherein the enclosure member forms a protruding ring on a periphery thereof, the protruding ring has a plurality of notches, the opening portion of the supporting member has a plurality of buckling protrusions, and each of the buckling protrusions is buckled into a respective one of the notches.

5. The motor base as claimed in claim 4, wherein the first surface of the enclosure member forms a protruding portion on the periphery of the enclosure member, and the protruding portion forms the protruding ring.

6. The motor base as claimed in claim 1, wherein the first surface of the enclosure member has a shaft seat.

7. The motor base as claimed in claim 1, wherein the coupling portion of the supporting member is coupled to a housing.

8. A motor base, comprising:
a supporting member having an outer surface and an inner surface, wherein the inner surface defines a through-hole, one side of the through-hole forms an opening portion and another side of the through-hole forms a coupling portion; and
an enclosure member coupled to the opening portion of the supporting member and having a first surface and a second surface opposing to the first surface, wherein the first surface faces the through-hole of the supporting member,
wherein the supporting member further comprises at least one ventilation opening extending from the outer surface to the inner surface thereof.

9. The motor base as claimed in claim 8, wherein the enclosure member forms a protruding ring on a periphery thereof, the protruding ring has a plurality of notches, the opening portion of the supporting member has a plurality of buckling protrusions, and each of the buckling protrusions is buckled into a respective one of the notches.

10. The motor base as claimed in claim 9, wherein the first surface of the enclosure member forms a protruding portion on the periphery of the enclosure member, and the protruding portion forms the protruding ring.

11. The motor base as claimed in claim 8, wherein the number of the at least one ventilation opening is two, and the two ventilation openings are opposing to each other.

12. The motor base as claimed in claim 8, wherein the first surface of the enclosure member has a shaft seat.

13. The motor base as claimed in claim 8, wherein the coupling portion of the supporting member is coupled to a housing.
